(19) United States
(12) Patent Application Publication
(10) Pub. No.: US 2026/0179082 A1
(43) Pub. Date: Jun. 25, 2026

(54) EXECUTING TRANSACTIONS IN BLOCKCHAIN SYSTEMS VIA TOKEN POOLS WITH CONVERTIBLE TOKENS

(71) Applicant: Circle Internet Group, Inc., New York, NY (US)

(72) Inventors: Keri Kaili WANG, Brooklyn, NY (US); Calvin CAI, Pittsburgh, PA (US); Michael GRANT, Canton, MA (US)

(21) Appl. No.: 19/535,040

(22) Filed: Feb. 10, 2026

Related U.S. Application Data
(63) Continuation of application No. 18/346,081, filed on Jun. 30, 2023.

(51) Int. Cl. G06Q 20/36; G06Q 20/38

(52) U.S. Cl. CPC G06Q 20/3672; G06Q 20/389

(57) ABSTRACT

Certain aspects provide techniques and apparatus for efficiently executing reversible transactions on a blockchain. An example method generally includes aggregating tokens from a plurality of wallets into a global pool of tokens. Generally, the global pool of tokens comprises a first type of token and a second type of token. A request to exchange a first quantity of the first type of token stored in a wallet to a second type of token is received. A second quantity of the second type of token to transfer to the wallet is calculated based, at least in part, on a ratio of the first type of token to the second type of token in the global pool of tokens. The first quantity of the first type of token is transferred to the global pool of tokens, and the second quantity of the second type of token is transferred to the wallet.

### CROSS-REFERENCE TO RELATED APPLICATIONS

This application is a continuation of U.S. patent application Ser. No. 18/346,081, filed Jun. 30, 2023, which is herein incorporated by reference.

### INTRODUCTION

Aspects of the present disclosure relate to transactions in blockchain systems, and more specifically to transactions executed via token pools.

### BACKGROUND

Blockchains can be used in various decentralized systems to provide a ledger of transactions that have occurred within these decentralized systems. Generally, a blockchain may include a chain of blocks, in which latest block includes some information about a transaction that occurred and a reference to an immediate predecessor block, which may be a hashed value of the previous block. Because the reference to the immediate predecessor block may be a value derived from the immediate predecessor block, verification of the transactions in the blockchain may be performed by ensuring that a hash of a block resolves to the same value as that stored as a reference to the immediate predecessor block in a succeeding block in the blockchain. If there is a mismatch between a computed hash of a block and the hashed value of the block in a succeeding block in the blockchain, validation of the blockchain may fail.

Generally, transactions recorded on a blockchain may be performed using one or more tokens which may be native to a blockchain or may be transacted on the blockchain. These different types of tokens may be exchangeable with each other; however, the supply of these tokens may vary for any number of reasons. Further, while some transactions may be executed based on multiple types of tokens, some transactions may be defined such that only a defined token can be used to execute these transactions. Thus, in order to execute a transaction, a user may exchange a first type of token for a second type of token, which may cause additional transactions to be executed on a blockchain and increase the amount of time and computational resources involved in executing a transaction on the blockchain.

Generally, transactions recorded on a blockchain are also immutable and irreversible once recorded and validated on the blockchain. Because transactions recorded on a blockchain are immutable and irreversible, the blockchain may be considered a source of truth for transactions that are recorded on the blockchain. Thus, performing transactions on a blockchain may allow for trust to be established between potentially unknown parties performing transactions on the blockchain. For example, the source of tokens transferred between parties on the blockchain may be trusted by virtue of users participating in these transactions recording such transactions on the blockchain.

However, the immutability and irreversibility of transactions on the blockchain may also create various security risks. For example, in a 51% attack, the transaction records stored on a blockchain may be modified if more than half of the nodes participating in processing transactions on the blockchain include a false record. In another example, because of the immutability and irreversibility of transactions on the blockchain, transactions that occur due to malicious attacks (e.g., transfers of tokens to attackers who demand cryptocurrency payments in order to reverse the effects of a ransomware attack) may not be reversed, and the victims of such attacks may not be able to recover tokens that are lost due to such attacks.

Accordingly, techniques are needed to improve the security and efficiency of transactions occurring on the blockchain.

### BRIEF SUMMARY

Certain embodiments provide a computer-implemented method for efficiently executing reversible transactions on a blockchain. An example method generally includes aggregating tokens from a plurality of wallets into a global pool of tokens. Generally, the global pool of tokens comprises a first type of token and a second type of token. A request to exchange a first quantity of the first type of token stored in a wallet to a second type of token is received. A second quantity of the second type of token to transfer to the wallet is calculated based, at least in part, on a ratio of the first type of token to the second type of token in the global pool of tokens. The first quantity of the first type of token is transferred to the global pool of tokens, and the second quantity of the second type of token is transferred to the wallet.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example computing system in which reversible transactions are performed on a blockchain using wrapped tokens, according to embodiments of the present disclosure.

FIG. 2 illustrates a timeline for executing a transaction for converting a first type of token to a second type of token on a blockchain using wrapped tokens, according to embodiments of the present disclosure.

FIG. 3 illustrates example operations for executing a transaction for converting a first type of token to a second type of token on a blockchain using wrapped tokens s, according to embodiments of the present disclosure.

FIG. 4 illustrates an example system on which embodiments of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Transactions in cryptocurrency systems may be represented as blocks in a blockchain that track a universe of transactions performed using the cryptocurrency system. In these cryptocurrency systems, processed transactions may not be modified at a later date, thus providing an immutable ledger of the transactions performed using the cryptocurrency system.

Using blockchain systems to perform and record transactions generally allows for transactions to be immutably recorded, which may allow for the blockchain to provide a consistent, unmodifiable record of transactions that have occurred on the blockchain and thus a consistent, unmodifiable transaction history for each user performing actions on a blockchain. The immutability and irreversibility of transactions on a blockchain, however, may allow malicious parties to perform malicious transactions that cannot be reversed. For example, hacks on wallets, transactions occurring due to scams executed against a wallet owner, thefts of tokens from wallets, and other attacks against wallets may occur from time to time, and the immutability and irreversibility of transactions performed on a blockchain may prevent victims from recovering tokens lost due to such attacks. Thus, transaction security and trust in a blockchain system may be negatively impacted by the immutability of a blockchain system and the irreversibility of transactions executed on blockchain systems.

In some cases, transactions may be performed on a blockchain using different, exchangeable tokens, the supply of which may vary within a user's wallet and within a larger overall universe of participants performing transactions on the blockchain. An individual user sending tokens to a recipient on the blockchain may thus wish to exchange one type of token for another type of token in order to perform a given transaction. However, in some situations, various complexities may arise due to the characteristics of these tokens. For example, wrapped tokens which can be used to perform reversible transactions may be in a recoverable state for some amount of time and may convert to a non-recoverable state after that amount of time has elapsed if the underlying transaction has not been flagged as fraudulent, malicious, or otherwise subject to reversal.

Aspects of the present disclosure provide techniques for performing transactions on a blockchain using tokens exchanged through a pool of tokens. Generally, a plurality of wallets may participate in a global pool in which tokens from the plurality of wallets are aggregated into the global pool. Users can exchange a quantity of a first token for a quantity of a second token, allowing the user to subsequently perform transactions using the second token. In some cases, the first token may be a wrapped token in a first state, and the second token may be the wrapped token in a second state into which the first token converts. By allowing for tokens to be exchanged through a global pool of tokens, aspects of the present disclosure may accelerate the process of executing transaction on a blockchain and reduce the computational expense involved in executing transactions on the blockchain, as a user may not need to wait for tokens to convert from a first type of token to a second type of token (e.g., from a token in a recoverable state to a token in a non-recoverable state) prior to using such tokens. Further, within the global pool of tokens, the supply of the second type of token may be continuously maintained when the first type of token converts over time to the second type of token, which may allow for exchanges to be fulfilled without executing additional transactions to replenish the supply of available tokens within the global pool. Further, aspects of the present disclosure may allow for recoverable tokens to be used within a global pool of tokens, which may improve security and trust in blockchain systems by allowing malicious transactions to be reversed and tokens recovered from the global pool, reducing the likelihood that parties to transactions performed on a blockchain will permanently lose tokens or other digital assets due to malicious transactions or malicious parties performing transactions on the blockchain.

### Example Transaction Processing on a Blockchain Using a Global Pool of Tokens

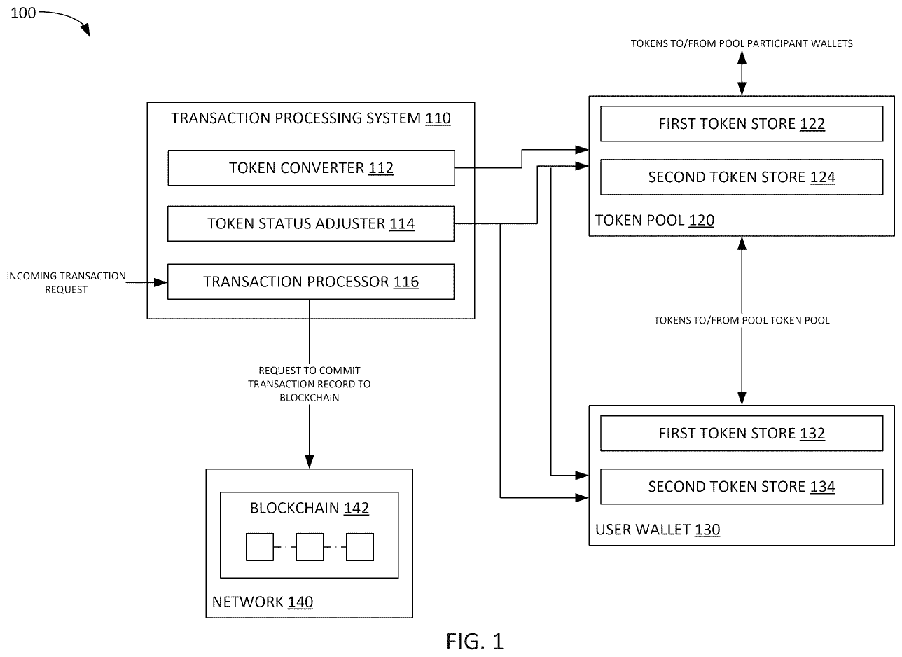

FIG. 1 illustrates an example computing environment 100 in which reversible transactions are performed on a blockchain using wrapped tokens, according to aspects of the present disclosure. As illustrated, computing environment 100 includes a transaction processing system 110, a token pool 120, a user wallet 130, and a network 140.

Transaction processing system 110 generally allows for tokens to be converted between different types of tokens, adjustment of the status of such tokens, and execution of transactions on blockchain 142 on network 140 based on the exchange of tokens between token pool 120 and user wallet 130. As illustrated, transaction processing system 110 includes a token converter 112, token status adjuster 114, and transaction processor 116.

Token converter 112 generally allows for the token pool 120 and/or a user associated with a wallet 130 to convert a first type of token to a second type of token. In one example, the first type of token may be a first type of token which can be used to execute transactions on a blockchain and a second type of token may be a different type of token which can also be used to execute transactions on the blockchain. In another example, the first type of token may be a wrapped token and the second type of token may be a base token encapsulated in the wrapped token. Reversible transactions may be performed using wrapped tokens, while irreversible transactions may be performed using base tokens.

A wrapped token generally allows for recoverability data to be added to a base token that may be used to perform transactions recorded on a blockchain. The recoverability data may include a recoverability status indicator and a frozen status indicator. The recoverability status indicator may be, for example, a Boolean value, with Boolean TRUE equating to the wrapped token being recoverable and Boolean FALSE equating to the wrapped token being nonrecoverable. Similarly, the frozen status indicator may also be a Boolean value, with Boolean TRUE equating to the wrapped token being frozen (and thus a token included in a transaction subject to reversal) and Boolean FALSE equating to the wrapped token being non-frozen.

Generally, where the first type of token is a wrapped token and the second type of token is the base token encapsulated therein, token converter 112 may allow for the first type of token to be converted to the second type of token when the first type of token is in a nonrecoverable state. Recoverable tokens may not be converted by token converter 112 into the base token, as these tokens may be subject to a status adjustment (e.g., may be frozen) and subsequent return to the originating wallet until the associated transaction is determined to not be fraudulent, malicious, or otherwise subject to reversal.

In some aspects, token converter 112 may be invoked when tokens are transferred from a token pool 120 to a user wallet 130, or vice versa. For example, when a user associated with user wallet 130 exchanges a first type of token for a second type of token via token pool 120, token converter 112 can convert tokens from second token store 124 into the second type of token prior to transmitting the tokens to user wallet 130. In an example in which the first type of token is a wrapped token and the second type of token is a base token encapsulated in the wrapped token, and in which first token store 122 stores the first type of token in a recoverable state and the second token store 124 stores the first type of token in a nonrecoverable state, token converter 112 can convert tokens from the second token store into the base token and output the base token to user wallet 130 for storage (e.g., in second token store 134, when first token store 132 is used to store wrapped tokens).

Token status adjuster 114 can modify tokens in token pool 120 or user wallet 130 to reflect the status of these tokens. For example, in a case where the first type of token is a wrapped token allowing for the token to be in a recoverable state or a nonrecoverable state, token status adjuster 114 can serve as a governance source that allows for tokens to be frozen when transactions performed on blockchain 142 in network 140 are determined to be potentially fraudulent or malicious (e.g., a transaction corresponds to a token theft event, malicious activity such as a ransomware attack in which cryptocurrency is used to obtain a decryption key to reverse the ransomware attack, etc.) and thus subject to reversal. When token status adjuster 114 determines that a transaction performed on blockchain 142 is a fraudulent or malicious transaction, token status adjuster 114 can flip the frozen status (e.g., change the frozen status from Boolean FALSE to Boolean TRUE) of the tokens involved in the transaction and stored in token pool 120 and/or user wallet 130. After freezing the tokens, token status adjuster 114 (or some other external governance source) can reverse the transaction or instruct transaction processor 116 to reverse the transaction. In reversing the transaction, the frozen tokens may be withdrawn from a token store in token pool 120 and/or user wallet 130 and returned to the sending wallet.

Transaction processor 116 generally receives and processes various requests to perform transactions involving token pool 120 and/or user wallet 130. Generally, transaction processor 116 can invoke a transfer of tokens between token pool 120, user wallet 130, and/or one or more other wallets (e.g., associated with participants in token pool 120) and commit transaction records reflecting these transfers to blockchain 142.

For example, to participate in token pool 120, a participant wallet (not illustrated) can contribute a quantity (also referred to as “staking”) of the first type of token and/or a quantity of the second type of token to token pool 120. Transaction processor 116 can record a transaction record on blockchain 142 evidencing the amount and types of tokens contributed by the participant wallet to the token pool and effectuate the transfer of the token(s) from the participant wallet to token pool 120. In some aspects, transaction processor 116 can record the transaction by invoking a smart contract or other programmatic construct on blockchain 142. This smart contract may allow for the initial transfer of tokens from the participant wallet and the token pool 120 and may also effectuate the distribution of tokens from token pool 120 to the participant wallets to provide compensation for contributing tokens to the token pool 120 to the users associated with the participant wallets. The distribution of tokens from token pool 120 to the participant wallets may be based on an aggregated delta between a received quantity of the first type of token and an exchanged quantity of the second type of token. The distribution of tokens from token pool 120 to the users associated with the participant wallets may be performed periodically or aperiodically, and the amount of tokens distributed from token pool 120 to the users associated with the participant wallets may be commensurate with the amount of tokens each participant wallet contributed to token pool 120.

In some aspects, transaction processor 116 can allow participant wallets to contribute various issuances of the first type of token to the token pool 120. Where the various issuances of the first type of token are fungible (that is, where a token issued by one issuer is interchangeable with a token issued by another issuer), token pool 120 can maintain an aggregated balance of the first type of token for future use (e.g., stored in first token store 122 for conversion to the second type of token and storage in second token store 124, as illustrated). Where the various issuances of the first type of token are nonfungible (that is, where a token issued by one issuer is not interchangeable with a token issued by another issuer), token pool 120 may segregate first token store 122 and second token store 124 on a per-issuer basis. Exchanges of tokens between token pool 120 and user wallet 130 may be performed on a per-issuer basis to reflect that tokens issued by different issuers are not interchangeable.

Generally, transaction processor 116 can receive requests to exchange a quantity of a first type of token in user wallet 130 (e.g., from first token store 132 of user wallet 130) for a quantity of a second type of token from token pool 120. To execute the request, transaction processor 116 can calculate quantity of the second type of token that is equivalent to the quantity of the first type of token specified in the transaction request and effectuate the transfer of the first type of token from user wallet 130 to token pool 120 and effectuate the transfer of the second type of token from token pool 120 to user wallet 130.

In one example, the first type of token may be a wrapped token in a recoverable state, and the second type of token may be a wrapped token in a nonrecoverable state or the base token encapsulated in the wrapped token. As discussed, wrapped tokens may remain in a recoverable state until some threshold amount of time has elapsed from the time at which the tokens were received a user wallet 130. Because wrapped tokens in a recoverable state involved in an exchange between user wallet 130 and token pool 120 may have some degree of uncertainty as to whether such tokens will migrate from a recoverable state to a nonrecoverable state, transaction processor 116 can exchange the amount of wrapped tokens in a recoverable state for a smaller amount of wrapped tokens in a non-recoverable state. The delta between the amount of amount of wrapped tokens in a recoverable state and the smaller amount of wrapped tokens in a non-recoverable state may be determined based on various metrics. For example, the delta may be based on a proportion of wrapped tokens in a recoverable state to wrapped tokens in a nonrecoverable state in token pool 120. As the proportion of wrapped tokens in the recoverable state to wrapped tokens in the nonrecoverable state increases, the delta may also increase. By adjusting the delta based on the composition of token pool 120, transaction processor 116 can allow for exchanges of wrapped tokens in a recoverable state for wrapped tokens in a nonrecoverable state that accounts for the risk that some tokens in the token pool 120 will be frozen and thus not be able to be converted to wrapped tokens in the nonrecoverable state.

In some aspects, the delta between the first quantity of the first type of token and the second quantity of the second type of token may also or alternatively be based on various risk-related metrics. These risk-related metrics may include the identity of the protocol from which the first type of token was sourced, historical risk metrics associated with the user associated with the user wallet 130, or the like. Generally, tokens generated by newer protocols or associated with historically high risk protocols may have larger deltas between the first quantity of the first type of token and the second quantity of the second type of token than more established protocols having lower risk profiles. It should be recognized that the risk-related metrics described herein are illustrative, and other risk-related metrics indicative of a likelihood that the first type of token will not be successfully converted to the second type of token.

In some aspects, a transaction to exchange a first type of token for a second type of token between token pool 120 and user wallet 130 may further include an unwrapping of a base token. In such a case, the first quantity of the wrapped token may be transferred from user wallet 130 to token pool 120, and transaction processor 116 can determine the second quantity of the wrapped token to be transferred from token pool 120 to user wallet 130 based on an exchange rate between these tokens and a calculated delta discussed above. The second quantity of the wrapped token may be unwrapped (e.g., through token converter 112), and the base tokens recovered by unwrapping the wrapped tokens may be transferred to user wallet 130. By doing so, the user associated with user wallet 130 may execute various transactions based on the base token or may wrap the tokens again prior to executing subsequent transactions on blockchain 142.

As discussed, within token pool 120, the quantity of the first type of token may eventually convert to a quantity of the second type of token. Generally, in allowing for exchanges of the first type of token for the second type of token, token pool 120 may be established such that there is a continuous supply of the first type of token that will eventually convert, at least in part, to the second type of token which can be used to satisfy subsequent exchange requests received at transaction processor 116 and committed to blockchain 142.

In aspects in which the first type of token is a wrapped token in a recoverable state and the second type of token is a wrapped token in a nonrecoverable state, tokens may be frozen by token status adjuster 114 when the transaction associated with these tokens (e.g., a transaction performed by the party which contributed the tokens to token pool 120) is determined to be fraudulent, malicious, or otherwise subject to reversal. In such a case, the tokens may be frozen and removed from the global pool of tokens. Subsequently, the tokens may be returned to the wallet from which these tokens originated (e.g., the transmitting wallet associated with the underlying transaction deemed to be fraudulent, malicious, or otherwise subject to reversal).

### Example Token Conversion Through a Global Pool of Tokens

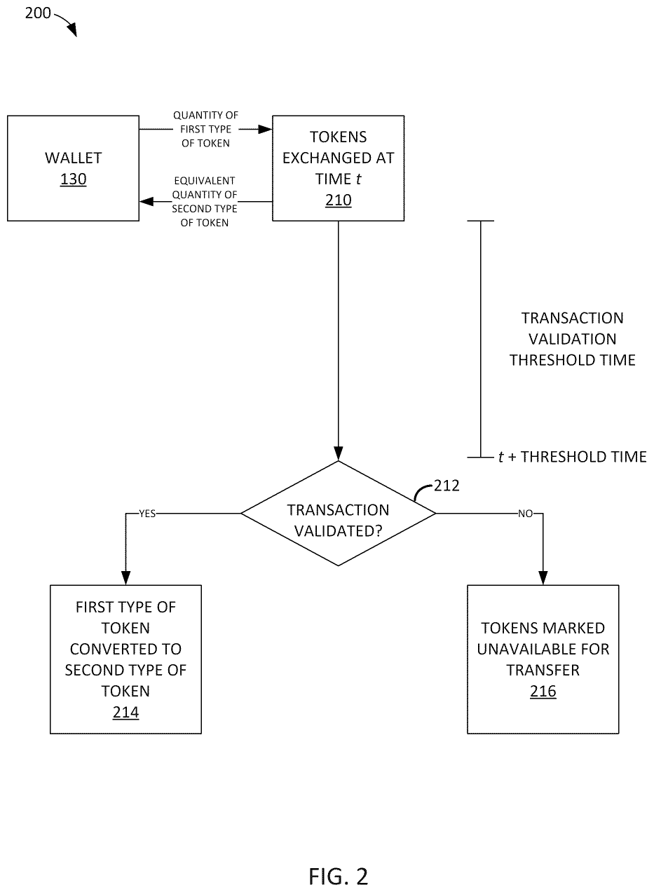

FIG. 2 illustrates a timeline 200 for executing a transaction for converting a first type of token to a second type of token on a blockchain using wrapped tokens, according to embodiments of the present disclosure.

As illustrated, in timeline 200, a token exchange transaction 210 is executed at time t. The transaction 210, as discussed, generally includes the transfer of a first type of token from a wallet 130 to a global pool of tokens and the transfer of an equivalent amount of a second type of token, less a defined delta, from the global pool of tokens to the wallet 130. In an example in which the tokens exchanged are wrapped tokens used in recoverable transactions, the tokens withdrawn from the transmitter wallet may be tokens in a recoverable state, while the tokens transferred from the global pool to the wallet 130 may be tokens in a nonrecoverable state or the base tokens encapsulated therein.

Before the threshold amount of time elapses (e.g., before time t+threshold_time), a governance authority (e.g., token status adjuster 114 illustrated in FIG. 1 and/or other governance authorities) can determine that an underlying transaction serving as the source of the first type of token in the transaction 210 is fraudulent, malicious activity, or otherwise subject to reversal. If the governance authority (or majority of governance authorities, in a case in which transactions and token freezes are validated on-chain) determines that a transaction is subject to reversal prior to the threshold time elapsing, the governance authority can determine that the tokens associated with the transaction can be frozen for future recovery.

At block 212, occurring one or after t+threshold_time, a transaction processor can determine whether the transaction associated with the exchange of first type of token for a second type of token has been validated as a legitimate transaction or has been determined to be fraudulent, malicious activity, or otherwise subject to reversal. If, at block 212, the transaction processor determines that the transaction has been validated as a legitimate transaction, the transaction processor can mark the tokens involved in transaction 210 as unrecoverable and, at block 214, convert the first type of token to the second type of token. For example, the tokens may be migrated to a portion of a wallet in which nonrecoverable tokens are stored, or the tokens involved in transaction 210 may have a status indicator updated to reflect that such tokens are now nonrecoverable tokens. The owner of the wallet receiving these tokens may perform subsequent transactions with these nonrecoverable tokens, such as executing further transactions involving the transfer of these nonrecoverable tokens, unwrapping these nonrecoverable tokens into the base token encapsulated therein, or the like.

If, however, at block 212, the transaction processor determines that the transaction associated with the first type of token provided to the global token pool via transaction 210 is fraudulent, malicious activity, or otherwise subject to reversal, then at block 216, the transaction processor can freeze the tokens associated with transaction 210. In some aspects, a single governance authority (e.g., token freezer 114 illustrated in FIG. 1) can be used to determine that a transaction is subject to reversal. In such a case, token freezer 114 can determine, at any point in time prior to the threshold amount of time elapsing, that a transaction is subject to reversal and can freeze the tokens associated with the transaction 210. That is, it should be understood that while timeline 200 illustrates the determination of a transaction 210 to be subject to reversal after the threshold amount of time has elapsed from the time at which transaction 210 was performed, the transaction can be deemed to be subject to reversal, and the corresponding tokens may be frozen, at any time prior to time t+threshold_time. In some aspects, where transaction reversibility and token freezing is performed based on a consensus derived from determinations by multiple governance authorities, a transaction 210 may be deemed to be subject to reversal if, at any point in time prior to the threshold amount of time elapsing, that a threshold number of governance authorities has determined a transaction to be fraudulent, malicious activity, or otherwise subject to reversal.

After the tokens are frozen at block 216, the tokens can be recovered at the transmitter wallet associated with the transaction serving as the source of the recoverable tokens at a wallet 130. To recover the tokens, a subsequent transaction may be recorded on blockchain 142 evidencing that the transaction is being reversed. The tokens may be removed from the transmitter wallet (and potentially from downstream transmitter wallets, as discussed above) and returned to the transmitter wallet through this subsequent transaction recorded on blockchain 142. The tokens removed from the transmitter wallet may, in some aspects, be tokens stored in a nonrecoverable token store and may be the tokens originally transferred to the transmitter wallet (e.g., in a case in which tokens are unique and nonfungible). This subsequent transaction to recover tokens may, in some cases, not be subject to a waiting period before the tokens involved in this subsequent transaction are deemed nonrecoverable; rather, based on determining that the tokens were transferred as part of a reversible transaction, the tokens returned to the transmitter wallet may be returned in a nonrecoverable state and made available for subsequent use.

### Example Operations for Token Conversion Through a Global Pool of Tokens

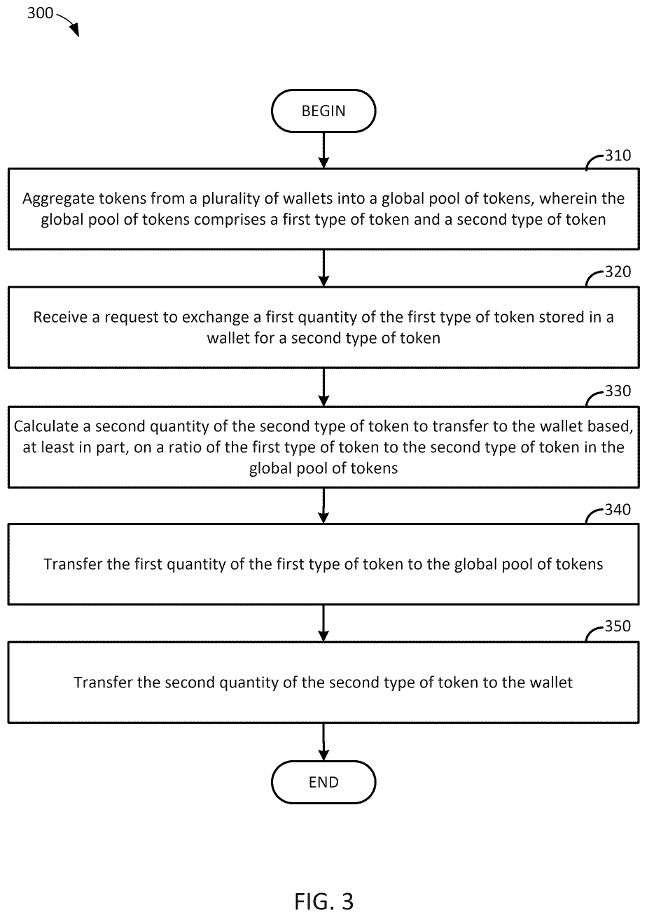

FIG. 3 illustrates example operations 300 for executing a transaction for converting a first type of token to a second type of token on a blockchain using wrapped tokens, according to embodiments of the present disclosure. Operations 300 may be performed, for example, by a transaction processing system (e.g., transaction processing system 110 illustrated in FIG. 1) that users associated with a wallet and a global pool of tokens use to exchange different types of tokens within a blockchain environment.

Operations 300 begin, as illustrated, at block 310, with aggregating tokens from a plurality of wallets into a global pool of tokens. The global pool of tokens generally comprises a first type of token and a second type of token.

In some aspects, the first type of token may include tokens encapsulating a base token and in a recoverable state. The second type of token may include tokens encapsulating the base token and in a non-recoverable state. As discussed, the first type of token may convert to the second type of token over time, such that a current supply of the first type of token may be the future supply of the second type of token usable in future exchange transactions with other wallets.

In some aspects, the second type of token may be a fungible token issued by any of a plurality of issuers.

In some aspects, the second type of token may be a nonfungible token in which tokens issued by one issuer are not fungible with tokens issued by another issuer. In such a case, operations 300 may further include segregating the first type of token in the global pool based on issuers of the first type of token. In such a case, requests to exchange the first type of token for the second type of token may be performed on a per-issuer basis.

At block 320, operations 300 proceed with receiving a request to exchange a first quantity of the first type of token stored in a wallet to a second type of token.

At block 330, operations 300 proceed with calculating a second quantity of the second type of token to transfer to the wallet based, at least in part, on a ratio of the first type of token to the second type of token in the global pool of tokens.

At block 340, operations 300 proceed with transferring the first quantity of the first type of token to the global pool of tokens.

At block 350, operations 300 proceed with transferring the second quantity of the second type of token to the wallet.

In some aspects, transferring the second quantity of the second type of token to the wallet, in an aspect in which the second type of token are tokens encapsulating the base token and in a non-recoverable state, includes unwrapping the second quantity of the second type of token to the second quantity of the base token. The second quantity of the base station may be transferred to the wallet.

In some aspects, operations 300 further include receiving an indication that a third quantity of the first type of token is frozen and removing the third quantity of the first type of token from the global pool of tokens.

In some aspects, the second quantity of the second type of token is less than the first quantity of the first type of token, and wherein the method further comprises allocating a delta between the first quantity and the second quantity for distribution to the plurality of wallets from which the global pool is drawn. The delta between the first quantity of tokens and the second quantity of tokens may increase as a proportion of the first type of token to the second type of token increases in the global pool.

In some aspects, operations 300 may further include distributing tokens to the plurality of wallets from which the global pool of tokens is drawn. As discussed, the tokens distributed to the plurality of wallets from which the global pool of tokens is drawn may be tokens associated with the delta between the first quantity of tokens and the second quantity of tokens. As the first quantity of the first type of token in which the delta was received converts to a second type of token, the accumulated amount of transaction deltas may be used to provide a benefit to parties that have contributed to the global pool of tokens. The distribution of tokens to the plurality of wallets may be based on the number of tokens contributed by each participating wallet to the global pool of tokens, a duration over which such tokens were contributed, and the like.

### Example System for Token Conversion Through a Global Pool of Tokens

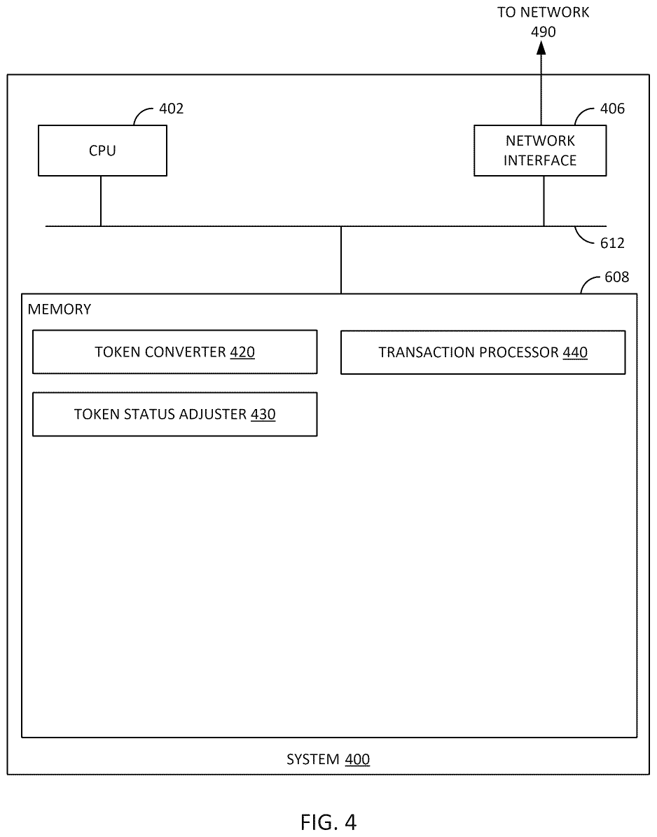

FIG. 4 illustrates an example system 400 configured to perform the methods described herein, including, for example, operations 300 of FIG. 3. In some embodiments, system 400 may act as a transaction processing service which receives requests to exchange tokens between a global token pool and a user wallet and commit records of such transactions to a blockchain, such as transaction processing system 110 illustrated in FIG. 1.

As shown, system 400 includes a central processing unit (CPU) 402, one or more I/O device interfaces 404 that may allow for the connection of various I/O devices 414 (e.g., keyboards, displays, mouse devices, pen input, etc.) to the system 400, network interface 406 through which system 400 is connected to network 690 (which may be a local network, an intranet, the internet, or any other group of computing devices communicatively connected to each other), a memory 408, and an interconnect 412. The I/O devices 414 and/or network interface 406 may be used to receive requests to bridge transactions between different blockchains, such as a Layer 1 blockchain and a Layer 2 blockchain.

CPU 402 may retrieve and execute programming instructions stored in the memory 408. Similarly, the CPU 402 may retrieve and store application data residing in the memory 408. The interconnect 412 transmits programming instructions and application data, among the CPU 402, I/O device interface 404, network interface 406, and memory 408.

CPU 402 is included to be representative of a single CPU, multiple CPUs, a single CPU having multiple processing cores, and the like.

Memory 408 is representative of a volatile memory, such as a random access memory, or a nonvolatile memory, such as nonvolatile random access memory, phase change random access memory, or the like. As shown, memory 408 includes a token converter 420, token status adjuster 430, and transaction processor 440.

Token converter 420 may correspond to token converter 112 illustrated in FIG. 1. Generally, token converter 420 allows for the creation of different types of tokens and the conversion of a first type of token to a second type of token. For example, token converter may allow for the creation of wrapped tokens from a base token and the unwrapping of base tokens from wrapped tokens. In creating a wrapped token, token converter 420 encapsulates a base token, which may be a token used in transactions performed and recorded on a blockchain, and adds additional features that allow for the base token to be placed in a recoverable or unrecoverable state and in a frozen state when tokens are transferred in a transaction marked as fraudulent, a result of malicious activity, or otherwise subject to reversal. Generally, token converter 420 may allow for tokens to be unwrapped into a base token when such tokens are in a nonrecoverable state, but may not allow for tokens to be unwrapped when such tokens are in a recoverable state (as these tokens may be associated with transactions that are subject to reversal and thus may be tokens that may be returned to the transmitter wallet).

Token status adjuster 430 may correspond to token freezer 114 illustrated in FIG. 1. Generally, token status adjuster 430 serves as a governance authority for transactions recorded on the blockchain to allow for transactions to be marked as fraudulent, malicious activity, or otherwise subject to reversal and to allow for the tokens transferred in these transactions to be frozen pending further review and/or returned to the transmitter wallet. Generally, token status adjuster 430 may determine that a transaction is subject to reversal, and thus that the associated tokens should be frozen pending a return of such tokens to the receiver wallet, at any time prior to an expiry time defined based on a timestamp associated with the transaction and a threshold amount of time to wait for a transaction to be verified (or for the transaction to be marked as subject to reversal). If token status adjuster 430 does not mark a transaction as subject to reversal before the expiry time, the transaction may be finalized, and the tokens transferred as part of the transaction may be migrated from a recoverable state to a nonrecoverable state. Otherwise, the transaction may be finalized, and the tokens may be moved from a recoverable token store to a nonrecoverable token store.

Transaction processor 440 may correspond to transaction processor 116 illustrated in FIG. 1. Generally, transaction processor 440 executes transactions on a blockchain and effectuates the transfer of tokens between a global token pool and a user wallet. Transaction processor 440 may receive a request to convert a first quantity of a first type of token to an equivalent amount of a second type of token and calculates a quantity of the second type of token that is sufficient to satisfy the request. Generally, transaction processor 440 can also determine a delta between the first quantity of the first type of token and the second quantity of the second type of token that serves as a premium for exchanging the first type of token for the second type of token (e.g., the conversion of a first type of token restricted for use in transactions performed on a blockchain to a second type of token unrestricted for use in transactions performed on a blockchain). The delta may be accumulated, and periodically or aperiodically, transaction processor 440 can generate and commit transaction records to a blockchain showing that a quantity of the second type of token was distributed to the participant wallets from which the global token pool was sourced. Finally, in some aspects, transaction processor can use requests to freeze a transaction in order to freeze the tokens and eventually effectuate a return of these tokens to the transmitting party associated with the original transaction from which the frozen tokens were received.

### Example Clauses

Implementation details for various aspects of the present disclosure are described in the following numbered clauses.

Clause 1: A computer-implemented method, comprising: aggregating tokens from a plurality of wallets into a global pool of tokens, wherein the global pool of tokens comprises a first type of token and a second type of token; receiving a request to exchange a first quantity of the first type of token stored in a wallet to a second type of token; calculating a second quantity of the second type of token to transfer to the wallet based, at least in part, on a ratio of the first type of token to the second type of token in the global pool of tokens; transferring the first quantity of the first type of token to the global pool of tokens; and transferring the second quantity of the second type of token to the wallet.

Clause 2: The method of Clause 1, wherein: the first type of token comprises tokens encapsulating a base token and in a recoverable state, and the second type of token comprises tokens encapsulating the base token and in a non-recoverable state.

Clause 3: The method of Clause 2, wherein transferring the second quantity of the second type of token to the wallet comprises: unwrapping the second quantity of the second type of token to the second quantity of the base token; and transferring the second quantity of the base token to the wallet.

Clause 4: The method of any one of Clauses 2 or 3, further comprising: receiving an indication that a third quantity of the first type of token is frozen; and removing the third quantity of the first type of token from the global pool of tokens.

Clause 5: The method of any one of Clauses 2 through 4, wherein the second type of token comprises a fungible token issued by any of a plurality of issuers.

Clause 6: The method of any one of Clauses 2 through 5, further comprising segregating the first type of token in the global pool based on issuers of the first type of token.

Clause 7: The method of any one of Clauses 1 through 6, wherein the second quantity of the second type of token is less than the first quantity of the first type of token, and wherein the method further comprises allocating a delta between the first quantity and the second quantity for distribution to the plurality of wallets from which the global pool is drawn.

Clause 8: The method of Clause 7, wherein the delta between the first quantity and the second quantity increases as a proportion of the first type of token to the second type of token increases in the global pool.

Clause 8: The method of any one of Clauses 7 or 8, further comprising distributed tokens to the plurality of wallets from which the global pool of tokens is drawn.

Clause 10: A system, comprising: a memory having executable instructions stored thereon; and a processor configured to execute the executable instructions to perform the operations of any one of Clauses 1 through 9.

Clause 11: A system, comprising: means for performing the operations of any one of Clauses 1 through 9.

Clause 12: A computer-readable medium having instructions stored thereon which, when executed by a processor, performs the operations of any one of Clauses 1 through 9.

### ADDITIONAL CONSIDERATIONS

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1-20. (canceled)

21. A computer-implemented method for controlling execution of blockchain transactions using convertible tokens, comprising:
receiving, at a transaction processing system, a request associated with a transfer of a token between a first wallet and a second wallet;
assigning, to the token, a recoverability state comprising at least a recoverable state and a non-recoverable state;
recording, in association with the token, a status indicator specifying whether the token is subject to reversal;
maintaining the token in the recoverable state for a defined time interval following the transfer;
during the defined time interval,
receiving an indication that the transfer is associated with a flagged condition; and
in response, modifying the status indicator to a frozen state and preventing further transfer of the token;
after expiration of the defined time interval and absent the flagged condition, automatically transitioning the token from the recoverable state to the non-recoverable state; and
enabling subsequent blockchain transactions using the token in the non-recoverable state.

22. The method of claim 21, wherein the recoverability state and the status indicator comprise Boolean values stored in association with the token.

23. The method of claim 21, wherein the defined time interval is determined based on a timestamp associated with the transfer and a threshold duration.

24. The method of claim 21, wherein the indication that the transfer is associated with the flagged condition is received from a governance authority configured to evaluate blockchain transactions.

25. The method of claim 24, wherein the flagged condition is determined based on a threshold number of governance authorities indicating that the transfer is subject to reversal.

26. The method of claim 21, further comprising:
in response to the status indicator being modified to the frozen state,
reversing the transfer by returning the token to the first wallet.

27. The method of claim 21, further comprising:
preventing conversion of the token to a base token while the token is in the recoverable state.

28. The method of claim 21, further comprising:
converting the token to a base token after the token transitions to the non-recoverable state.

29. The method of claim 21, further comprising:
storing the token in a global token pool during the defined time interval,
wherein tokens in the global token pool comprise both recoverable tokens and non-recoverable tokens.

30. A computer-implemented method for exchanging tokens via a token pool, comprising:
receiving a request to exchange a first quantity of a first type of token associated with a first state for a second type of token associated with a second state;
determining a second quantity of the second type of token based on:
a composition of tokens within a token pool, and
a risk metric associated with the first type of token;
transferring the first quantity of the first type of token to the token pool;
transferring the second quantity of the second type of token from the token pool; and
allocating a difference between the first quantity and the second quantity to a distribution pool associated with contributors to the token pool.

31. The method of claim 30, wherein the risk metric is based on at least one of:
a source protocol associated with the first type of token; or
a historical transaction profile associated with a user.

32. The method of claim 30, wherein the difference increases as a proportion of recoverable tokens in the token pool increases.

33. The method of claim 30, further comprising:
segregating tokens in the token pool based on issuer when tokens are non-fungible.

34. The method of claim 30, further comprising:
distributing accumulated differences to a plurality of wallets based on contributions to the token pool.

35. A system comprising:
a token converter configured to:
convert tokens between a recoverable state and a non-recoverable state;
a token status controller configured to:
assign and update status indicators associated with tokens, including a frozen status; and
a transaction processor configured to:
enforce transfer restrictions based on the status indicators, and
execute blockchain transactions based on token state transitions.
